(19) United States
(12) Patent Application Publication
(10) Pub. No.: US 2018/0039829 A1
(43) Pub. Date: Feb. 8, 2018

(54) CONTINUOUS, SELF-EXECUTING VERIFICATION WORKSHEET SYSTEM

(71) Applicant: Roger D. Summers, St. Louis, MO (US)

(72) Inventor: Roger D. Summers, St. Louis, MO (US)

(21) Appl. No.: 15/666,558

(22) Filed: Aug. 1, 2017

Related U.S. Application Data
(60) Provisional application No. 62/371,060, filed on Aug. 4, 2016.

(51) Int. Cl. G06K 9/00; G06F 17/21

(52) U.S. Cl. CPC G06K 9/00469; G06F 17/211

(57) ABSTRACT

A Continuous Verification process (CVP) utilizes a field-fillable document conversion process to, among other things, analyze pertinent metrics, regulatory guidelines, industry standards, and/or specifications outlined or contained in any document to define a “rules set” and then compares real-time entries (inputs) that were identified in the converted document to the rules, during any procedural execution of the document. Converted documents are known as a Continuous Verification Worksheet (CVW). After conversion, any metric, regulatory guideline or specification identified in the document not matching the metric, regulatory guideline or specification inputted during a CVW operational procedure, may halt or fail the procedure until the metric, regulatory guideline or specification can be qualified to match the specified CVW document requirement(s).

### CROSS-REFERENCE TO RELATED APPLICATION

This application claims the benefit of U.S. Provisional Application 62/371,060, filed Aug. 4, 2016.

### BACKGROUND

Software platforms exist in several forms to maintain existing quality management systems (QMS). They encompass document management, inventory control, electronic monitoring systems (used primarily for industrial manufacturing equipment), instrument management, sequential out of specification programs, corrective and preventative action forms and other QMS aspects. The traditional and still most widely used approach for managing quality management systems and recording the actions preformed during a procedure are pen and paper (notebooks) and document archiving. These platforms are limited in that the processes and systems they maintain can only identify a mistake or failure after an entire process or procedure has been performed.

The existing systems can be defined as a post-process or post production quality review, to insure their compliance metrics. Where, after a procedure or process is preformed, all of the associated data is assembled and collected, then reviewed for accuracy. This often occurs days or even months after the procedure has been completed and may take several days or even weeks to audit. Errors are often introduced into the process or a compliance metric was not accurately met during the procedure. This will result in a failed process or production event and repeat procedures. They could lead to citations issued by the regulatory agencies. Mandating additional reviews and corrective actions, costing the business and the regulatory body's significant resources and delayed products to market. Business often implement several of these unrelated software platforms with traditional recordkeeping to assist in the management of their quality systems, adding additional complexity to their systems. None of these platforms provide any ability for any off-site auditing or review. Neither do these platforms provide a single comprehensive electronic compliance solution that can manage every aspect of a business QMS from project inception to final product or result and the ability to track each element electronically.

Existing systems such as Trackwise (Sparta Systems Inc.) or Delta V (Rockwell Int.) can be used to predominately monitor process metrics for some large-scale production manufacturing equipment. They may alert personnel to take action or fail a procedure and halt production in the event some tolerance value(s) has exceeded operational values. These platforms are capable of issuing electronic batch records that contain details about specific, equipment operational parameters monitored throughout the procedure. They do not possess the electronic capability to track or fail materials used during those processes prior to or inserted into the procedure during execution. In most cases they are unable to capture any external action taken to insure the process, which must be recorded elsewhere. After the production event the externally recoded elements are assembled and included as a supplement to the batch record. The external record would undergo a post-production quality review procedure as described above with all associated risks.

### BRIEF SUMMARY OF THE INVENTION

The following presents a simplified summary in order to provide a basic understanding of some aspects of the invention. This summary is not an extensive overview. It is not intended to identify key or critical elements of the invention or to delineate the scope of the invention. The following summary merely presents some concepts of the invention in a simplified form as a prelude to the more detailed description provided below.

According to aspects of the present invention, a Continuous Verification process (CVP) utilizes a field-fillable document conversion process to, among other things, analyze pertinent metrics, regulatory guidelines, industry standards, and/or specifications outlined or contained in any document to define a “rules set” and then compares real-time entries (inputs) that were identified in the converted document to the rules, during any procedural execution of the document. Converted documents are known as a Continuous Verification Worksheet (CVW). After conversion, any metric, regulatory guideline or specification identified in the document not matching the metric, regulatory guideline or specification inputted during a CVW operational procedure, may halt or fail the procedure until the metric, regulatory guideline or specification can be qualified to match the specified CVW document requirement(s).

According to aspects of the present invention, CVWs comprise the first element of a comprehensive Real Time Compliance enterprise system platform encompassing additional business related and regulatory functions. Modules such as out of specification (OOS), corrective action and preventative action (CAPA), inventory management, customer complaints, citations, etc. may be utilized to ensure compliance. These exemplary modular elements may be contained within a single platform and auditable back to the initiation of any process.

Additionally, aspects of the present invention may allow regulatory agencies or any third party to conduct audits remotely via a desktop application, a web-based application or other appropriate interfaces. Advantageously, this may reduce and, in many instances, eliminate the need for costly and time consuming on-site visits.

### BRIEF DESCRIPTION OF THE DRAWINGS

FIG. 1 illustrates an exemplary diagram of an exemplary embodiment of a Real Time Compliance (“RTC”) enterprise system platform, according to various aspects described herein.

FIG. 2 illustrates an exemplary RTC/CVW process flow, according to various aspects as described herein.

FIG. 3 illustrates an exemplary login user interface of an exemplary RTC/CVW process, according to various aspects as described herein.

FIGS. 4A-4E illustrate exemplary user interfaces of an exemplary RTC/CVW process, according to various aspects as described herein.

FIGS. 5A-5F illustrate exemplary user interfaces of an exemplary RTC/CVW process when generating an exemplary CVW, according to various aspects as described herein.

FIGS. 6A-6J illustrate exemplary user interfaces of an exemplary RTC/CVW process when generating an exemplary CVW, according to various aspects described herein.

FIG. 7 illustrates an exemplary diagram of an exemplary halting/overriding process, according to various aspects described herein.

FIG. 8 is an exemplary block diagram illustrating an example of a computing device, according to aspects of the present invention.

### DETAILED DESCRIPTION

In the following description of the various embodiments, reference is made to the accompanying drawings, which form a part hereof, and in which is shown by way of illustration various embodiments in which features may be practiced. It is to be understood that other embodiments may be utilized and structural and functional modifications may be made.

According to aspects of the present invention, a Continuous Verification process (CVP) utilizes a field-fillable document conversion process to, among other things, analyzes pertinent metrics, regulatory guidelines, industry standards, and/or specifications outlined or contained in any document (such as, but not limited to, an operational procedures, standard work, protocols, batch record, etc.) to define a “rules set” (alternately, “rules”) and compares real-time entries (inputs) that were identified in the converted document to the rules, during any procedural execution of the document. Converted documents are known as a Continuous Verification Worksheet (CVW). After conversion, any metric, regulatory guideline or specification identified in the document not matching the metric, regulatory guideline or specification inputted during a CVW operational procedure, may halt or fail the procedure until the metric, regulatory guideline or specification can be qualified to match the specified CVW document requirement(s). This immediate review, pre-process verification procedure defines a new process for maintaining internal business, government regulatory compliance and other compliance standards in contrast to the existing (and traditional) methodologies involving post-process review approaches.

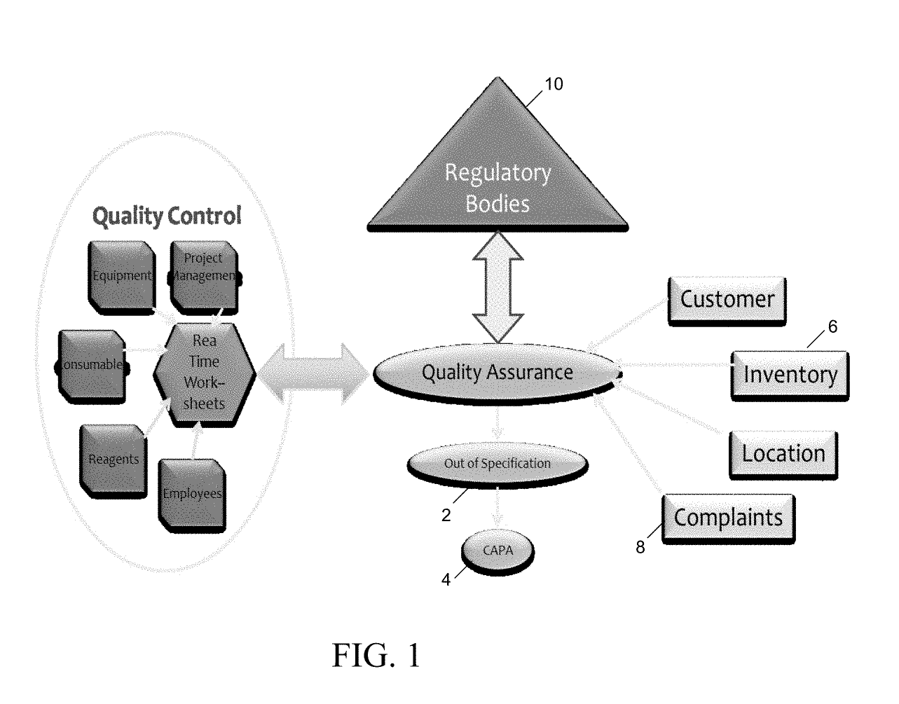

According to aspects of the present invention, CVWs are the first element of a comprehensive Real Time Compliance enterprise system platform encompassing additional business related and regulatory functions, as illustrated in FIG. 1. As demonstrated by the exemplary diagram in FIG. 1, modules such as out of specification (00S) 2, corrective action and preventative action (CAPA) 4, inventory management 6, customer complaints 8, citations (not shown), etc. may be utilized to ensure compliance. These exemplary modular elements may be contained within a single platform and auditable back to the initiation of any process. Additionally, aspects of the present invention may allow regulatory agencies 10 to conduct audits remotely via a desktop application, a web-based application or other appropriate interfaces. Advantageously, this may reduce and, in many instances, eliminate the need for costly and time consuming on-site visits.

According to aspects of the present invention, one or more elements of the process may be contained (with the exception of an optional desktop application link) as a Microsoft word add-on application stored in a memory or storage device of a tablet-based computing device and may be used in conjunction with lanyard-worn universal product code (UPC) scanning hardware, such as but not limited to, a wireless (e.g., wifi, NFC, or other appropriate communication method or protocol) UPC scanner. All data is collected via the tablet computing device and stored on remote hardware server databases (cloud infrastructure). Data can then be accessed either the tablet device or through the Archware desktop application. An exemplary scanner and tablet are illustrated in Exhibit A.

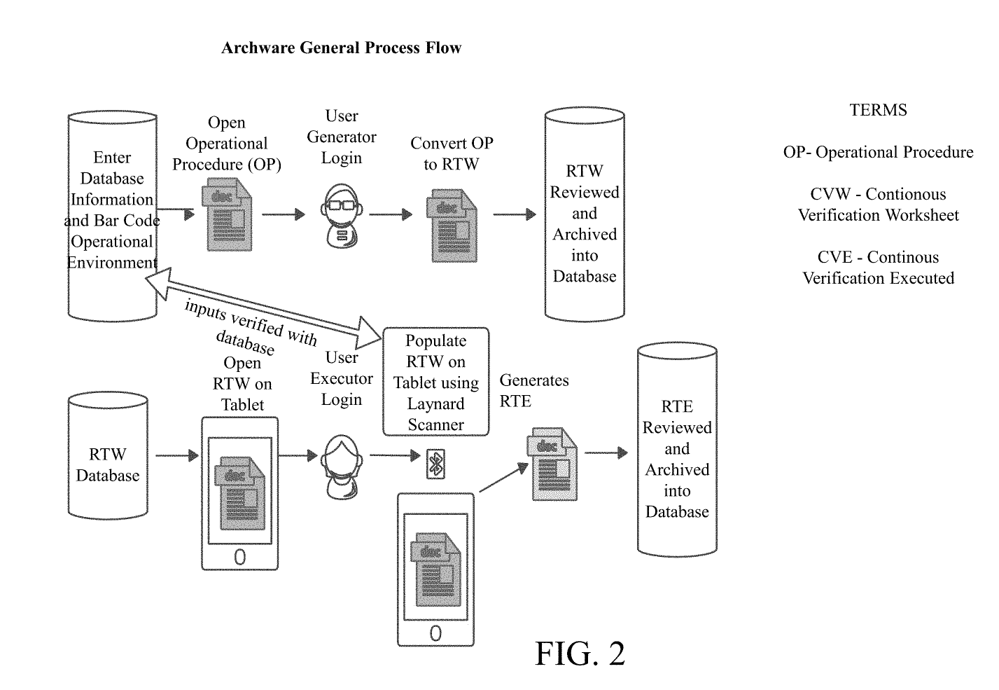

One or more exemplary CVW systems, methods, devices, apparatuses, or some combination thereof, may utilize one or more computer applications developed for use with a word processor, e.g., Microsoft Word. For example, according to aspects of the present invention, a business's Microsoft Word documents may be converted, updated, or otherwise altered to accept Real Time Inputs (RTI) from a source, such as but not limited to, a user, one or more computing devices (e.g., hand-held scanner, mounted scanner, mobile device with a camera, etc.), some combination thereof, or other appropriate means of data collection/data entry. An exemplary process flow, illustrating one or more exemplary steps, is illustrated in FIG. 2. This “conversion process” enables, among other things, the creation of CVWs from those Word documents. As described herein and illustrated in the FIGURES, documents may be selected, opened and converted by selecting the appropriate tab along the ribbon bar. After the ribbon tab is selected, a series of icons are presented in the ‘tool box’ for use in converting a document to a Continuous Verification Worksheet. The user selects (e.g., highlights in a step-wise fashion) areas of the document containing any action that requires a user to record or otherwise provide information or to verify that any process has been performed.

After identifying the specific action within the document, the user then selects (e.g., highlights) the individual action components contained within or for that action. Action components comprise individual items such as the instruments, reagents, consumables, etc., or in some instances, activities such as time, stir, shake, heat, etc. that may be necessary to complete the entire action identified. After the action or action component has been identified, an appropriate action or action component icon in the tool box may be selected and activated (clicked). After action components are selected, the document may be modified to insert and present blank entry fields in relation to the highlighted selection(s), e.g., the blank entry field may be positioned after, alongside, below (or other appropriate position) the highlighted selection. The inserted fields may comprise specific headers (e.g., lot number, instrument ID, manufacture, date, calibration, etc,) as required by internal use or regulatory agencies for the specific action component identified. These blank fields may capture information and then compare and verify that information against any Code of Federal Regulation (CFR), International Standards organization (ISO), other international regulatory requirements, internal company requirements, business requirements, or some combination thereof (e.g. “rules). For example, exemplary action(s) and action component description(s) may include something like: Action—Weigh 10 g NaCl. Action Components (from the above action)—Weigh, 10, g and NaCl. Generally, those individuals who are ‘skilled in the art’ within their respective business will be able to intuitively identify how the action and action component icons are to be applied within a document for conversion to a CVW. After the document has been converted to a CVW, the CVW may be, among other things, reviewed, approved, secured, archived for use, or some combination thereof.

CVWs are used in conjunction with tablet computing devices using Bluetooth infrared technology and small lanyard worn, Universal Product Code (UPC) scanning instruments. A user may scan an item, such as a reagent bottle in a laboratory, and based on the scan, one or more aspects of the present invention may indicate one or more CVW is required. If so, the CVW is released to the user to capture any information contained within, required, or specified by that CVW. After a user entry (e.g., a manual entry, information collected by infrared transmission, scanned information, etc.), the information, is immediately compared against the metric, regulatory guideline or specification identified from the CVW conversion process. If the entry does not meet, equal, match or comply with the action, action component or regulatory guideline required at the time of input, the CVW may halt the procedure. CVW may continue the action(s) after the appropriate (correct or matching) entry components have been collected or any required approvals have been initiated. For example, an appropriate CVW (e.g., a required Standard Operating Procedure (SOP)) may be released for procedural execution. A user may scan an item and the scan information is referenced against CVW requirements for accuracy. In some instances, the scanned item may identify a correlation required to execute the RTI field correctly, where the completion of another CVW may be necessary. If so, that CVW will present itself on the table for execution that the current CVW may accept the required input. By way of demonstration and not limitation, the scanning of an instrument may require a calibration check before it may be used. A scan is initiated and the instrument calibration check may be made, where it may be determined that the instrument is ‘out of calibration’. An associated procedure for performing an instrument calibration may then be presented. After executing the calibration, the instrument calibration information may be updated, allowing its accepted use with the previous CVW.

Non-manual inputs to CVWs are maintained through, for example, one or more tables, data stores, databases, system memory, or some combination thereof. This information may be utilized to auto populate the appropriate fields contained within the CVW after collection or scan. Entries to the databased may be reviewed, approved, maintained, or secured before any CVW data collection or scan may be initiated. Generally, no non-manual inputs may be entered for an action or action component that does not meet the associated metric, regulatory requirement or specification at the time of collection, where an appropriate error message may inform the user of the specific failure. Manual inputs are handled in the same manner after data entry (input) is rejected and cleared, then informing the user of the specific failure.

As should be apparent, aspects of the present invention allow for entirely electronic/digital systems, methods, devices, apparatuses, or some combination thereof, for reviewing and auditing to ensure appropriate compliance, regardless if the reviewer/auditor is on-site or at a remote location. Aspects of the present invention enable the entire process from inception to completion, with all associated data and results.

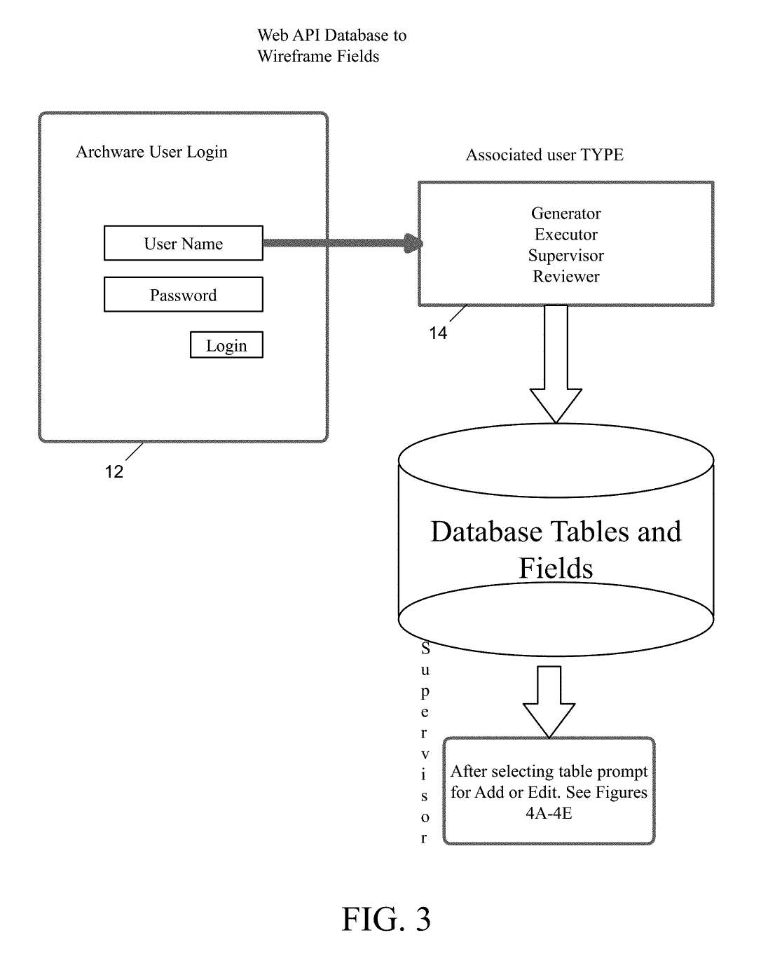

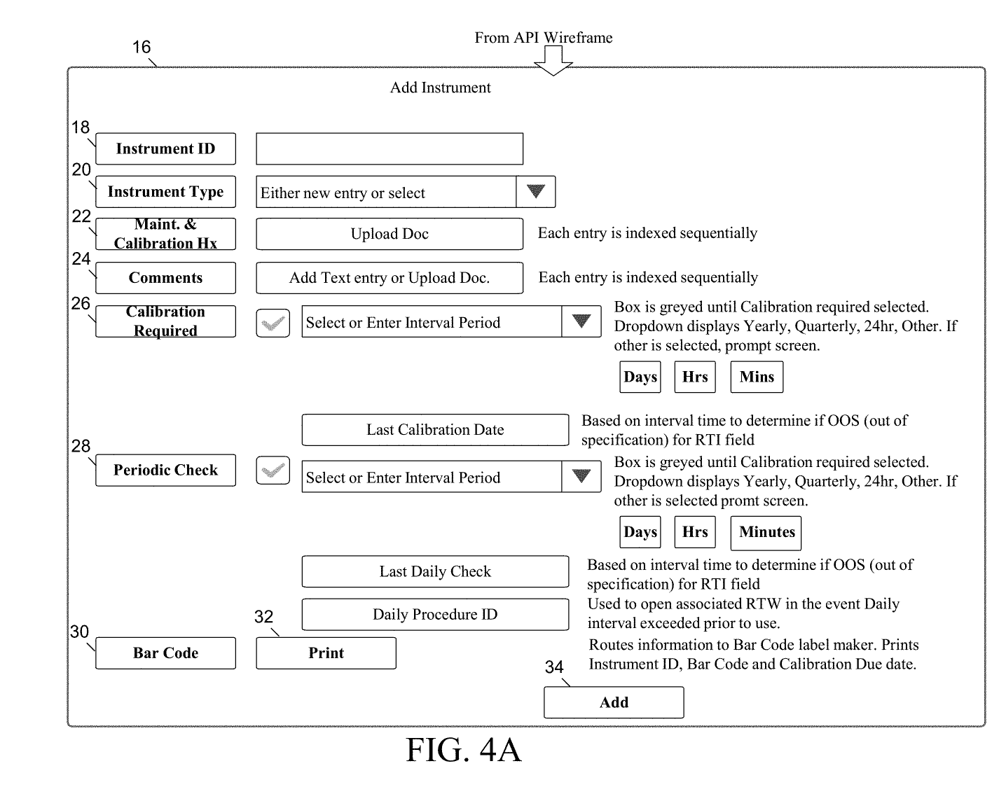

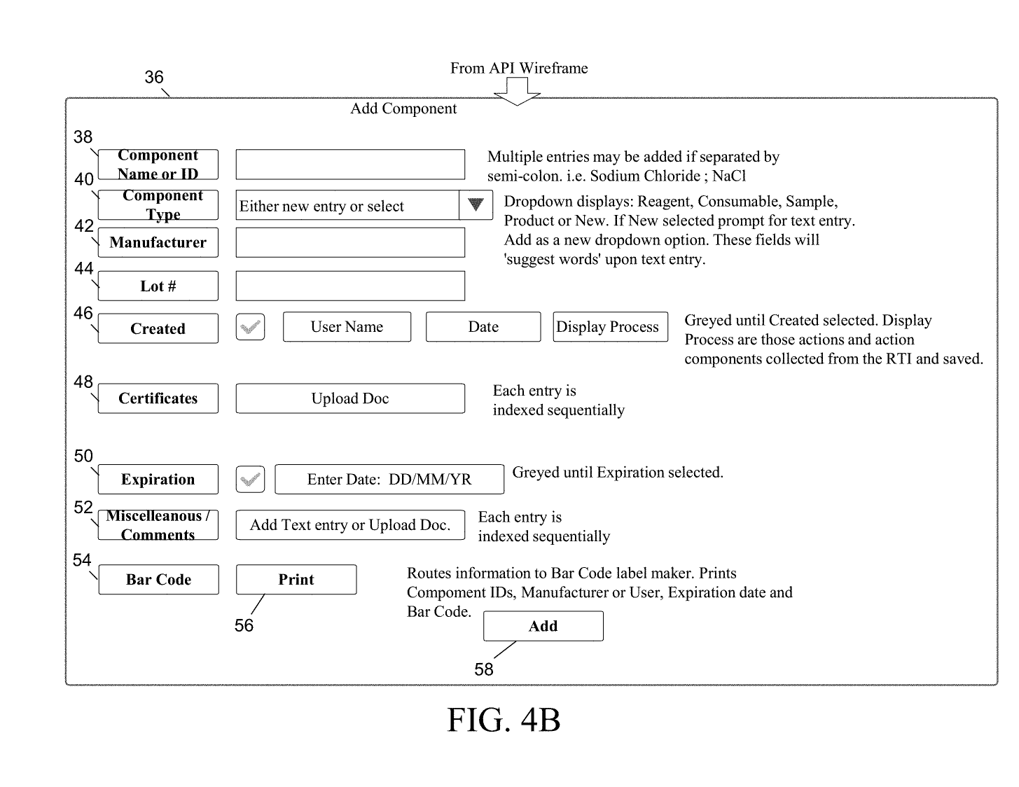

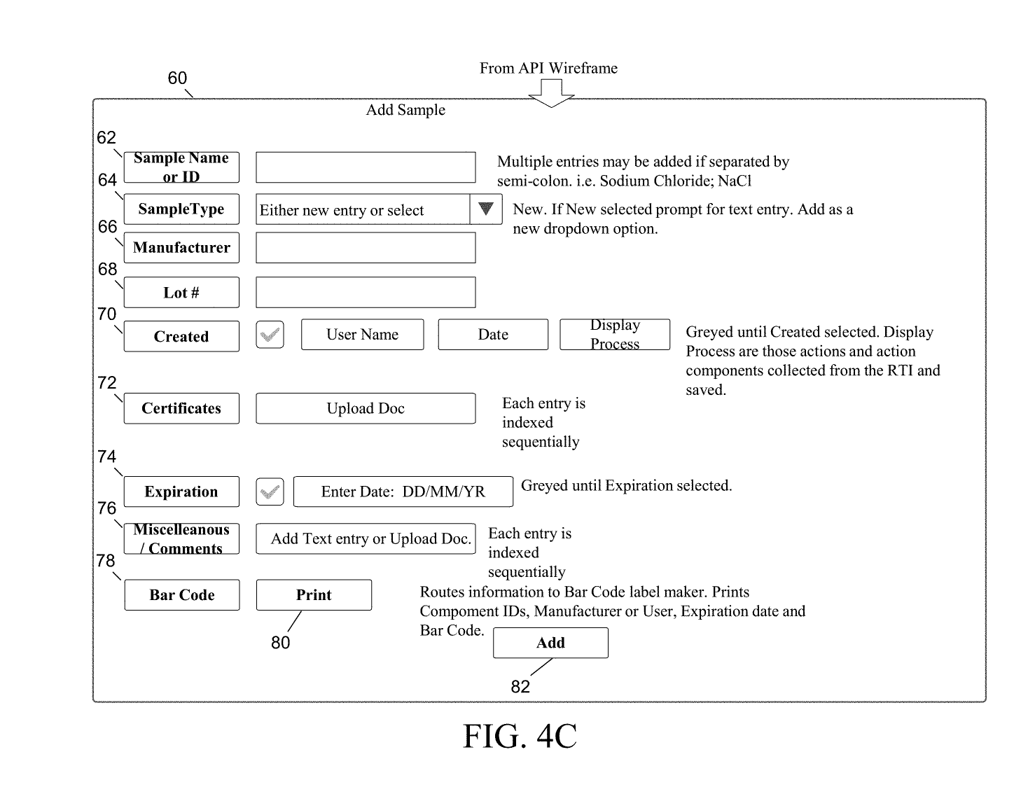

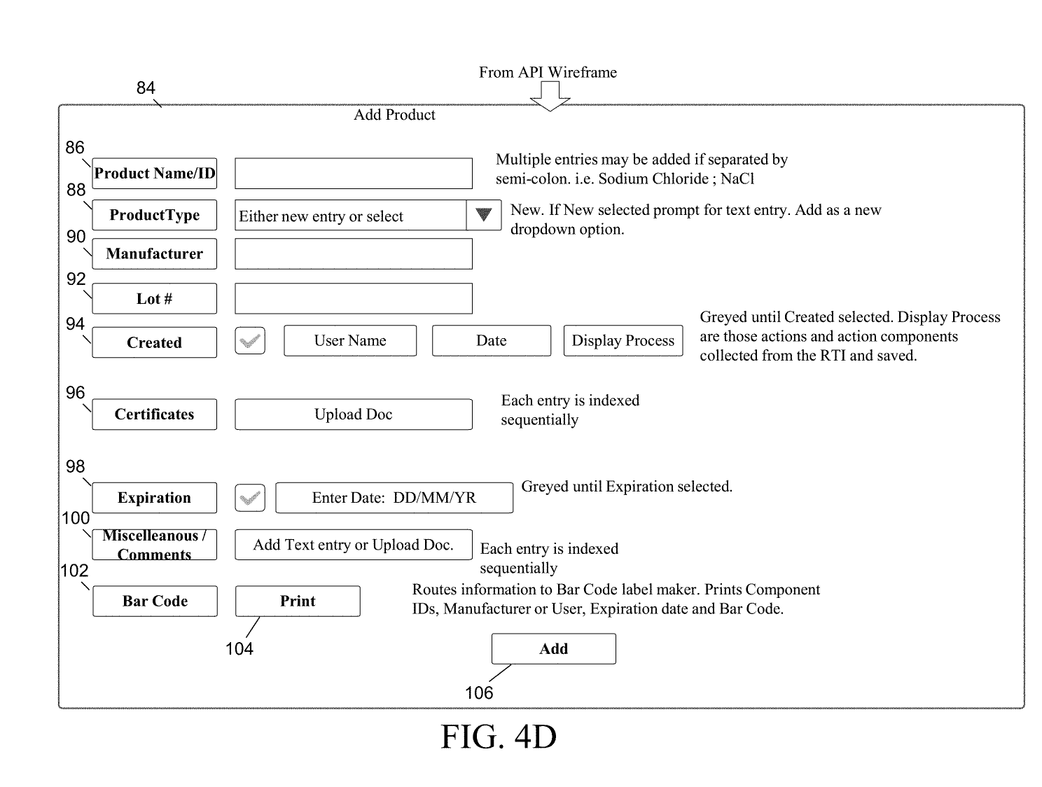

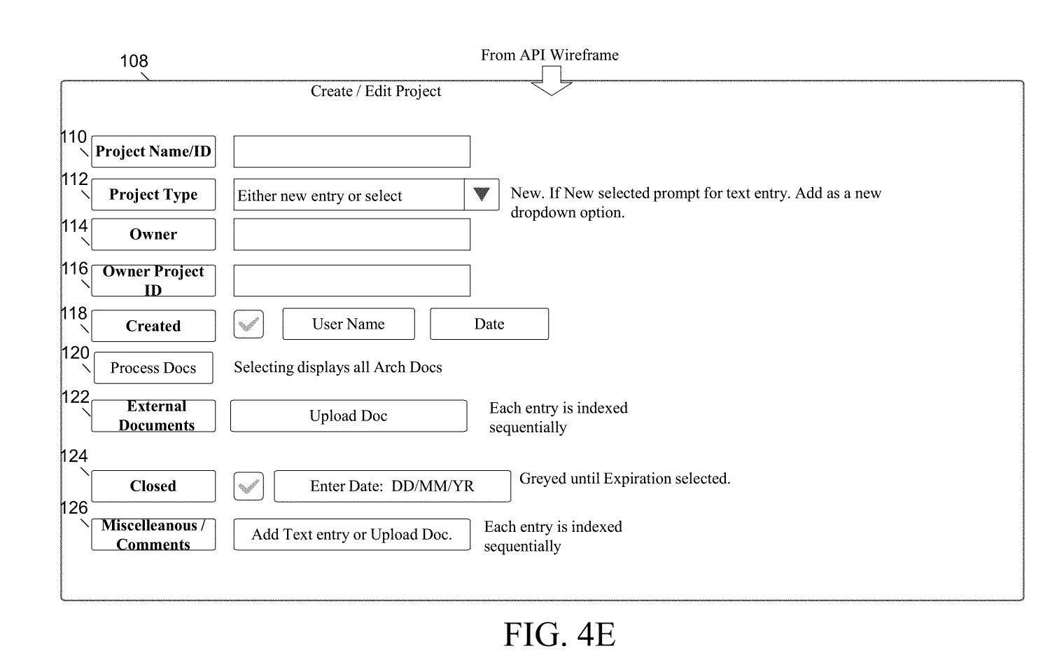

Various aspects and exemplary implementations may illustrated in the FIGURES and Exhibit A. Exhibit A describes various aspects of an exemplary system embodying aspects of the present invention. For example, FIG. 3 provides an exemplary diagram that illustrates an exemplary user login 12, with each associated user having an associated type 14. If the user type indicates that the user is authorized to add/edit information in the database, the user may proceed to one or more of the exemplary user interfaces (“UI”, or alternately, “screen(s)”) demonstrated in FIGS. 4A-4D, with FIG. 4E illustrating an exemplary UI for crediting/editing a project.

For example, FIG. 4A illustrates an “Add Instrument” exemplary UI 16, where a user may add a new instrument to the database by entering information about the instrument, for example, instrument ID 18, instrument type 20, maintenance & calibration history 22, comments 24, calibration required 26, periodic check 28, bar code 30, other pertinent information, or some combination thereof. The user may then print a bar code 32 and/or add the instrument to the database 34. FIG. 4B illustrates an “Add Component” exemplary UI 36, where a user may add a new component to the database by entering information about the component, for example, component ID 38, component type 40, manufacturer 42, lot number 44, created 46, certificates 48, expiration 50, comments 52, bar code 54, other pertinent information, or some combination thereof. The user may then print a bar code 56 and/or add the instrument to the database 58. FIG. 4C illustrates an “Add Sample” exemplary UI 60, where a user may add a new sample to the database by entering information about the sample, for example, sample ID 62, sample type 64, manufacturer 66, lot number 68, created 70, certificates 72, expiration 74, comments 76, bar code 78, other pertinent information, or some combination thereof. The user may then print a bar code 80 and/or add the instrument to the database 82. FIG. 4D illustrates an “Add Product” exemplary UI 84, where a user may add a new product to the database by entering information about the product, for example, product ID 86, product type 88, manufacturer 90, lot number 92, created 94, certificates 96, expiration 98, comments 100, bar code 102, other pertinent information, or some combination thereof. The user may then print a bar code 104 and/or add the instrument to the database 106. FIG. 4E illustrates an “Create/Edit” exemplary UI 108, where a user may add a create or edit a project in the database by entering/editing information about the project, for example, project ID 110, project type 112, owner 114, owner project ID 116, created 118, process documents 120, external documents 122, closed date 124, comments 126, other pertinent information, or some combination thereof. The user may then print a bar code 80 and/or add the instrument to the database 82.

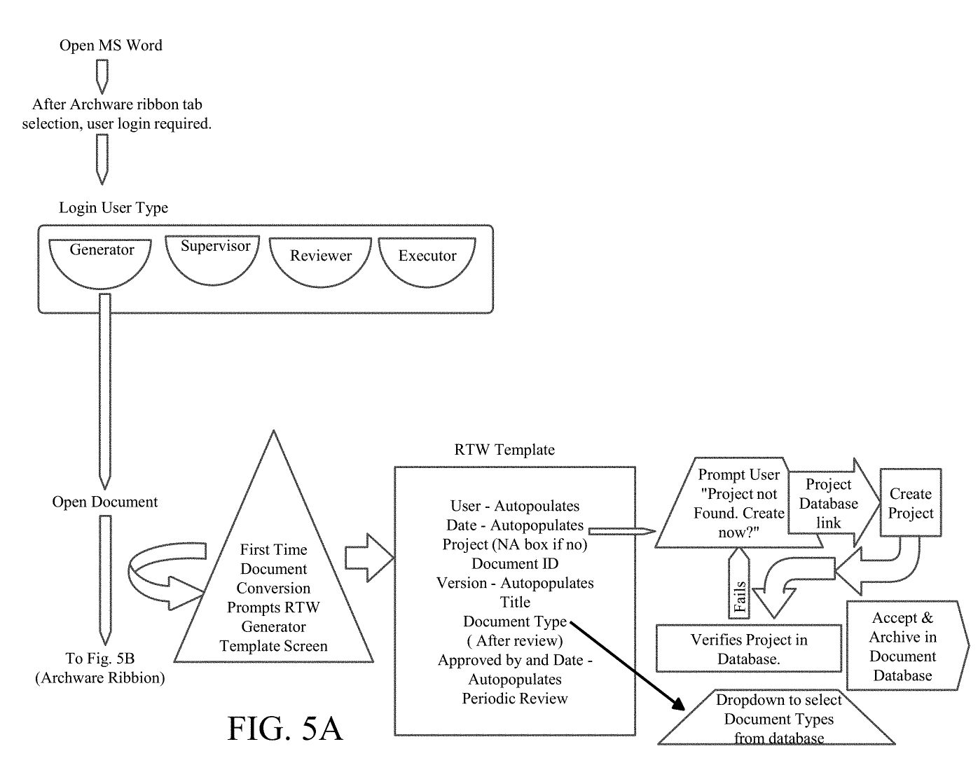

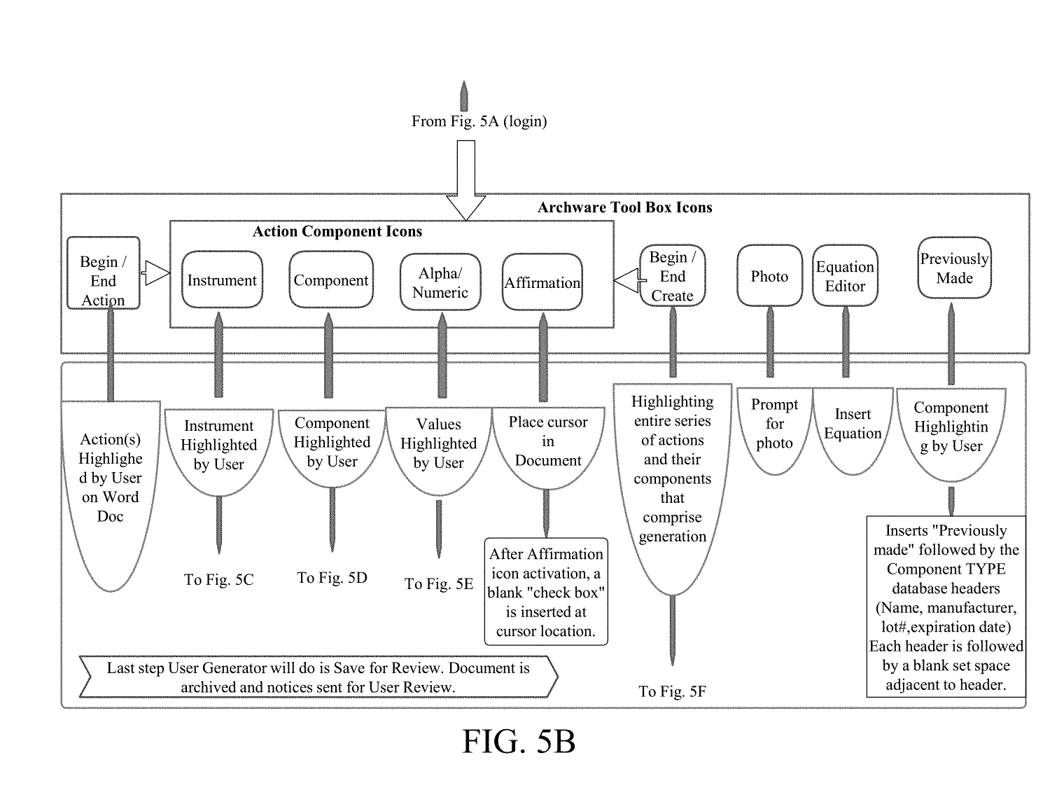

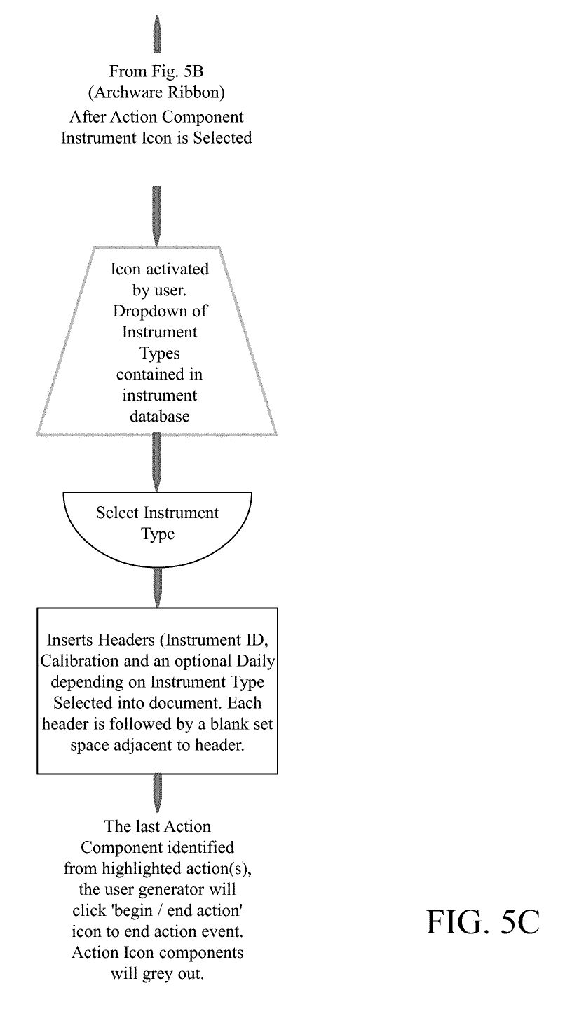

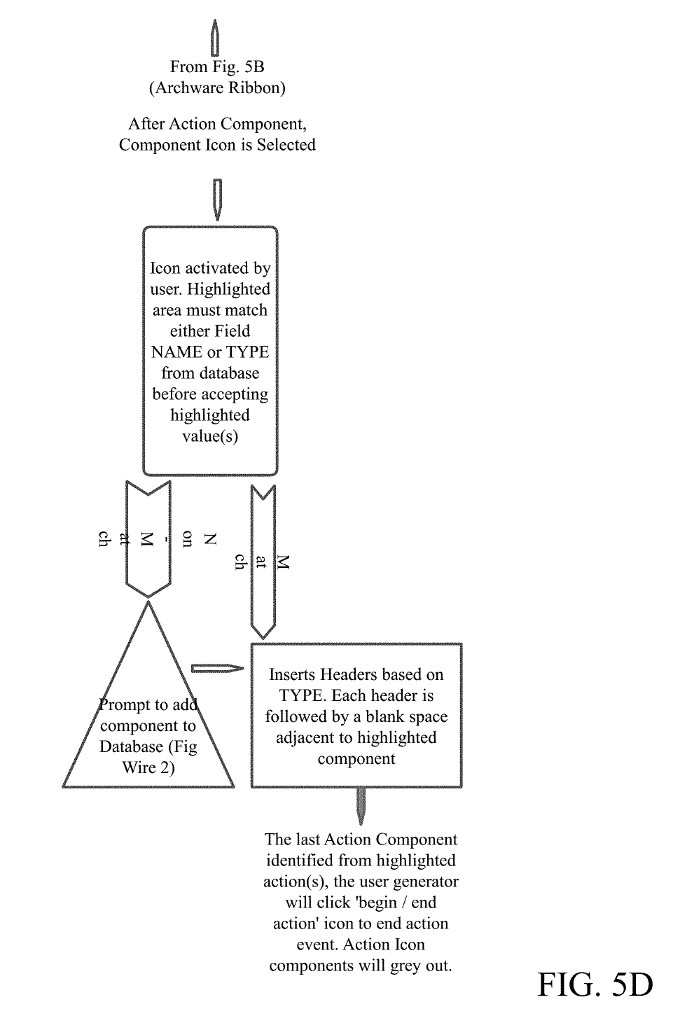

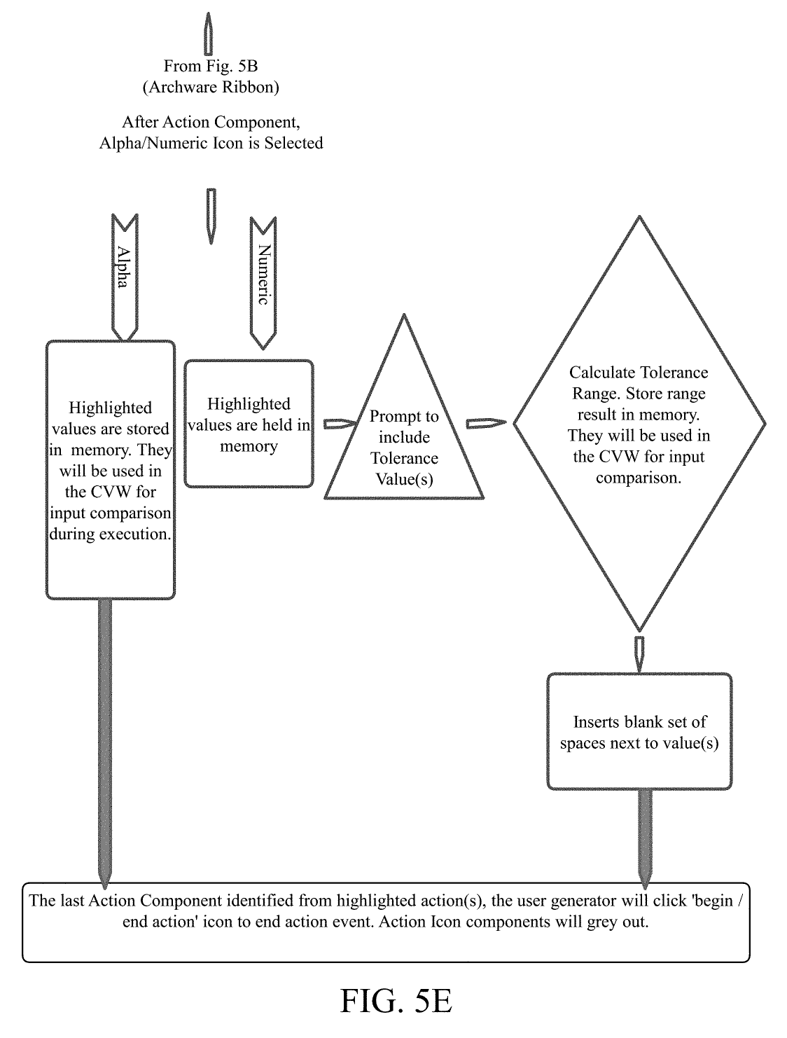

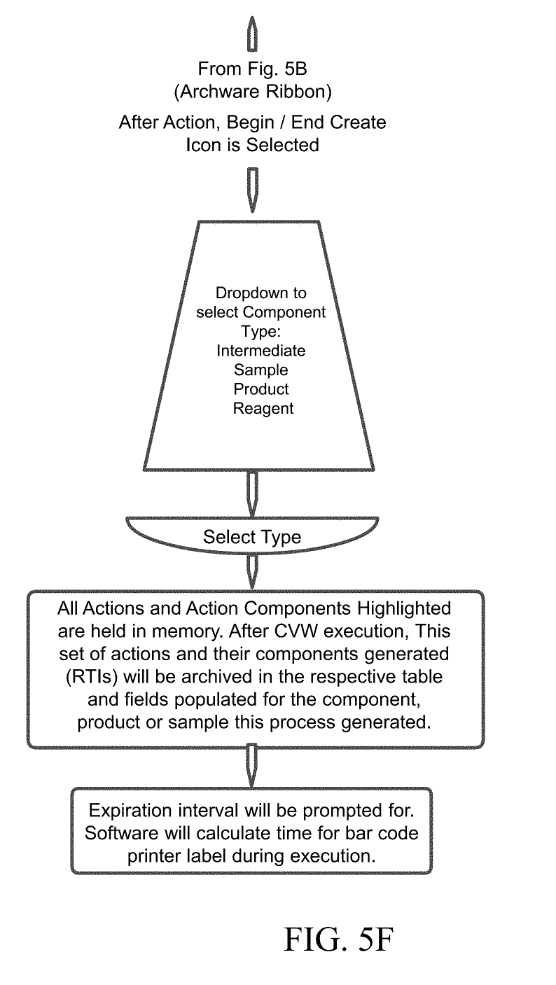

Turning now to FIG. 5A, when the user type of the user indicates a “generator” type, the process is further illustrated by the exemplary process diagram in FIG. 5A for generating a CVW. This exemplary process proceeds generally as illustrated in the additional FIGURES. For example, FIG. 5B proceeds from the elements illustrated in FIG. 5A, whereby the user may select one or more toolbox icons to indicate one or more desired actions/elements/steps. As noted in FIG. 5B, different actions/elements/steps proceed to one or more additional exemplary processes, such as those demonstrated in FIG. 5C-5F.

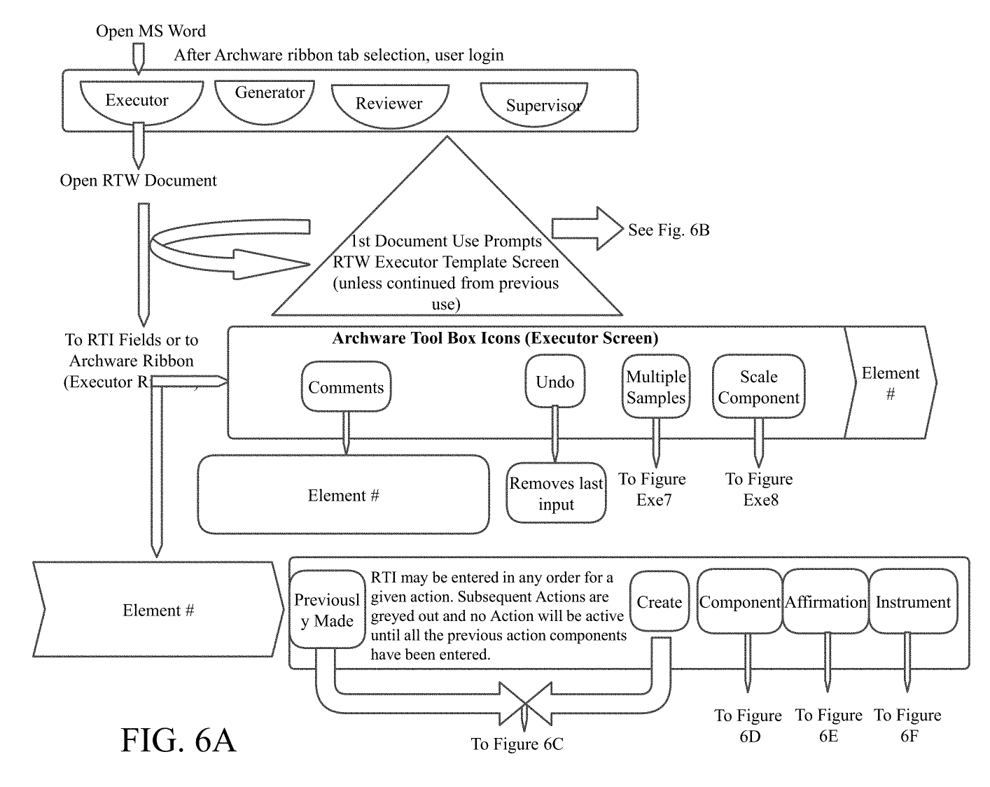

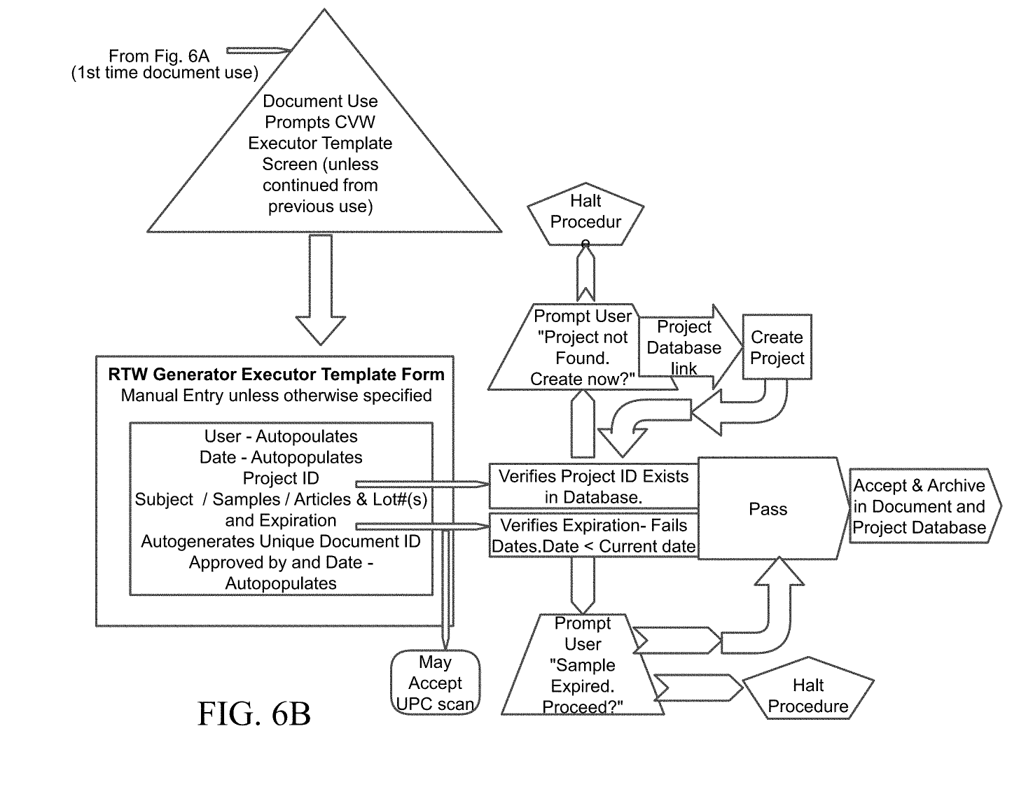

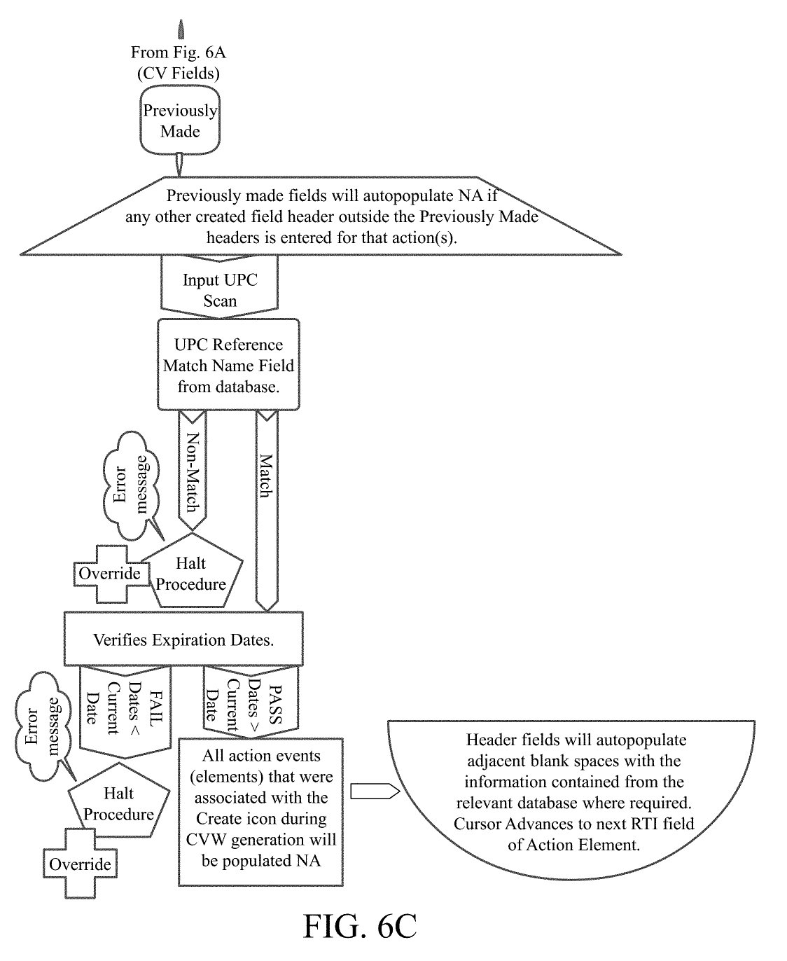

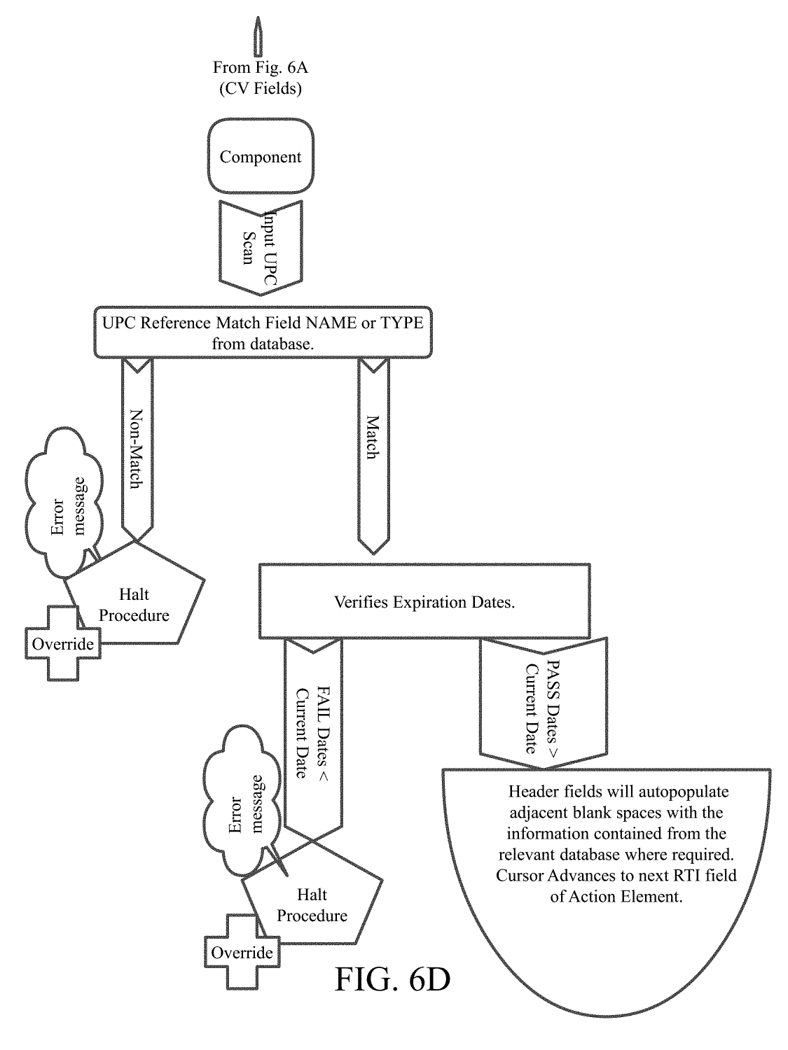

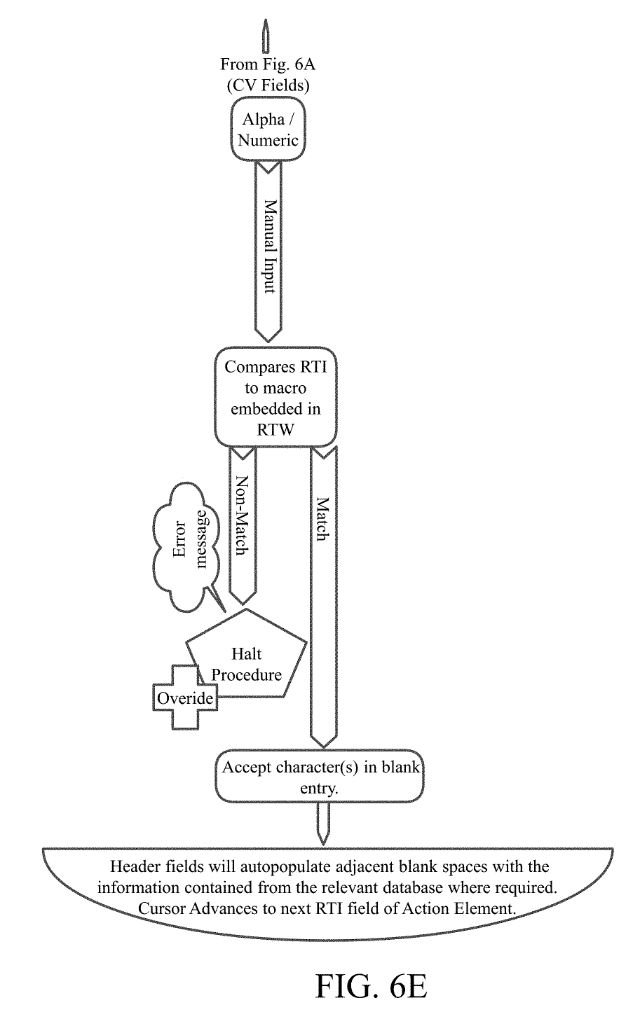

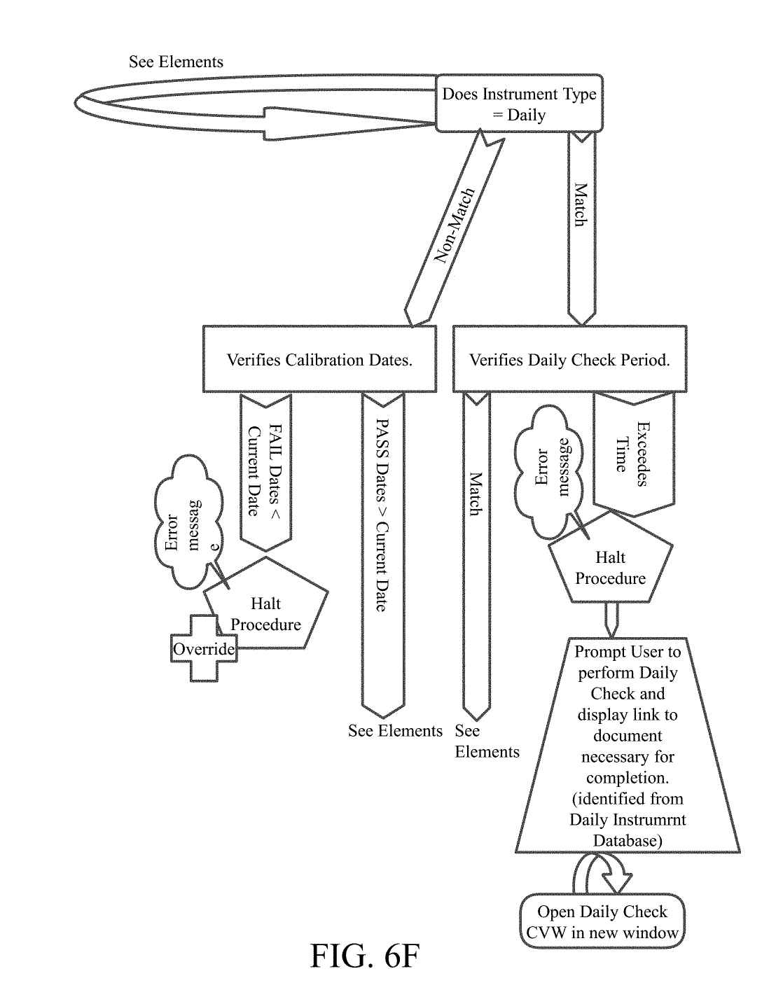

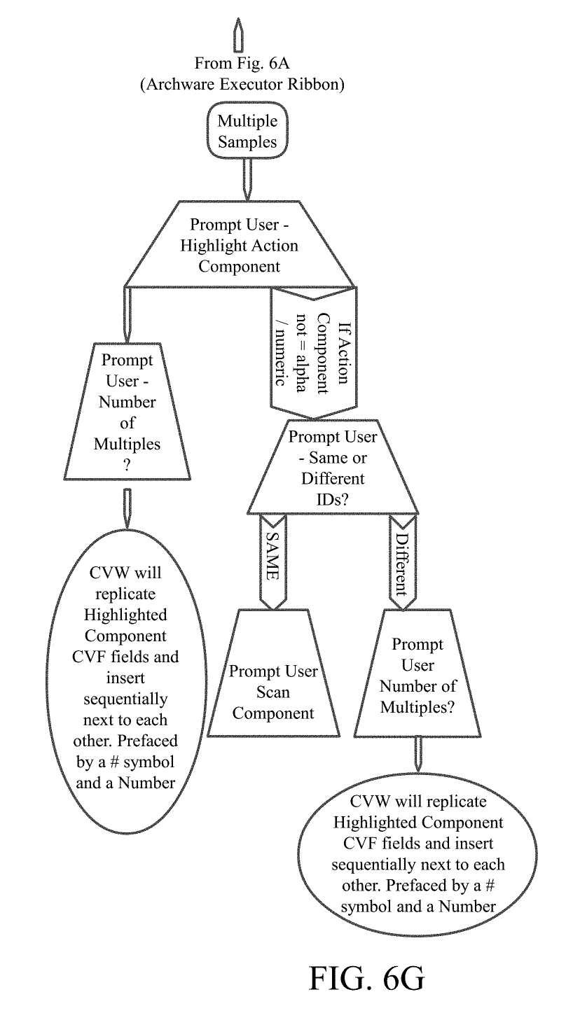

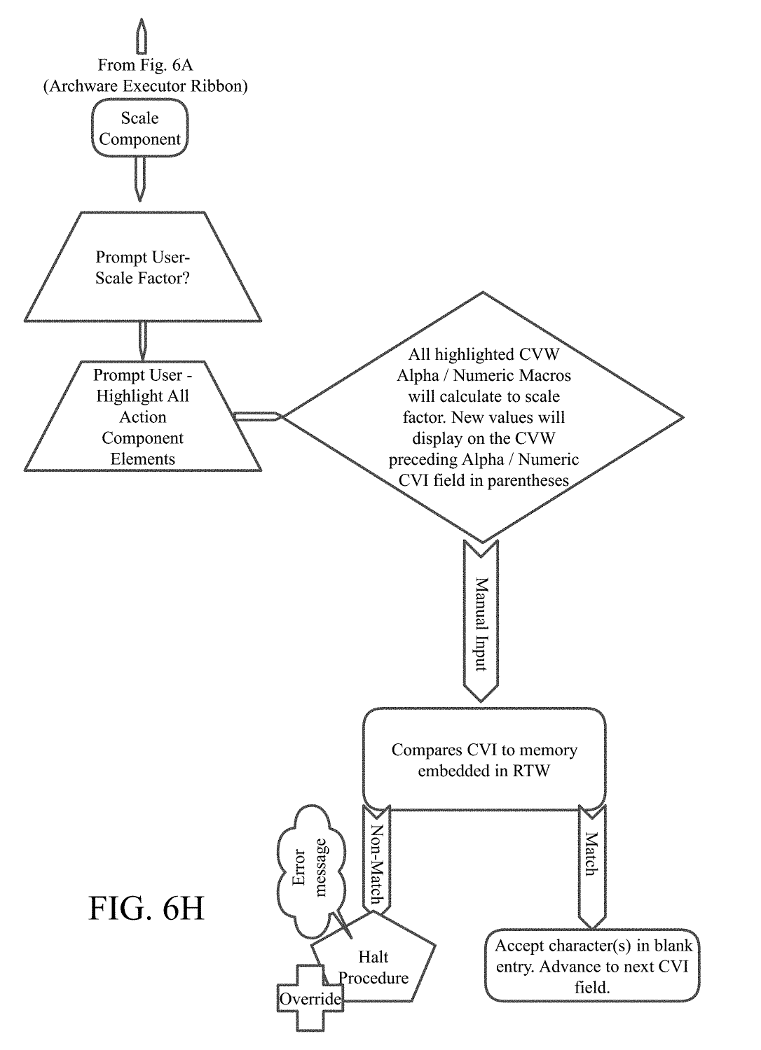

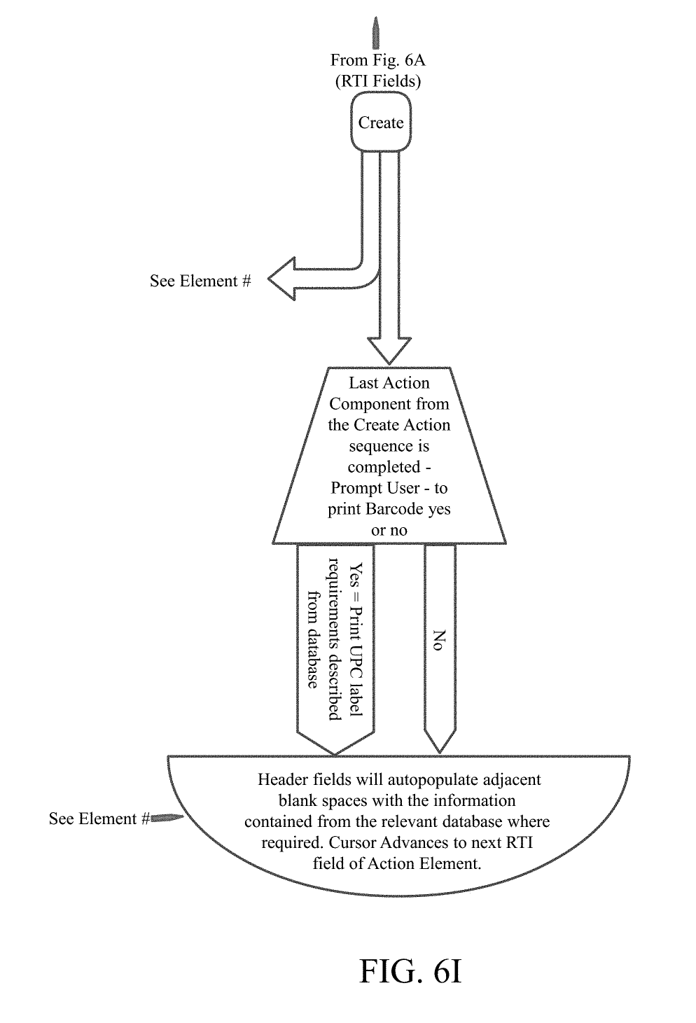

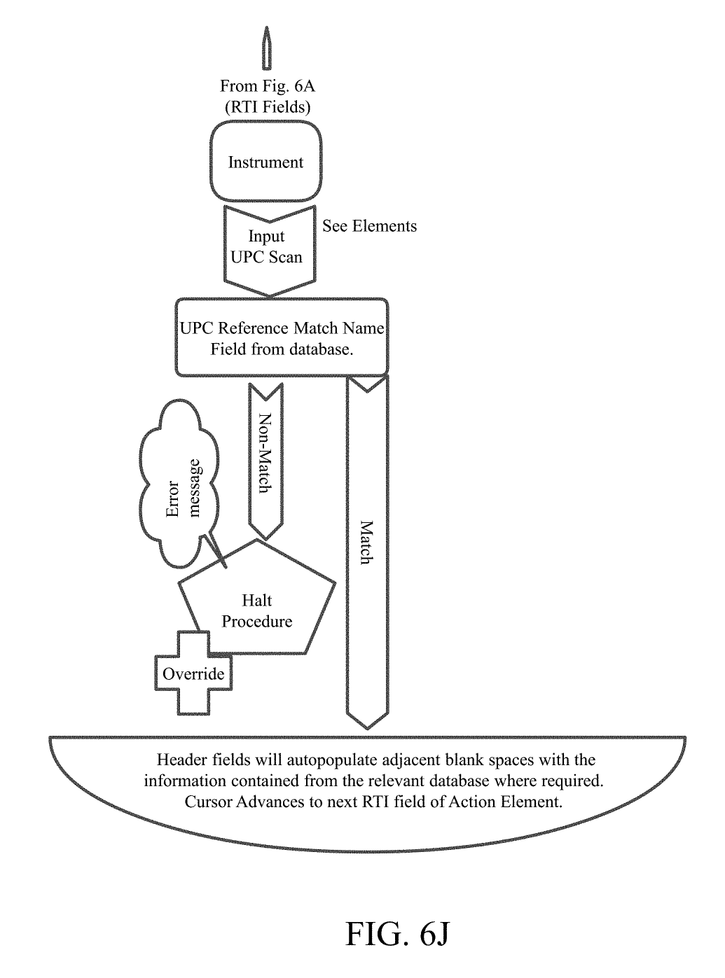

When the user type of the user indicates an “executor” type for entering real-time data/inputs and executing a CVW to validate the data/inputs, FIGS. 6A-6J illustrate exemplary processes, according to aspects of the present invention.

When the user type of the user indicates a “supervisor” type, the user may, among other things, perform a review of one or more documents after CVW generation, perform a review of one or more documents after CVW execution, provide override and/or approval functionality during execution of one or more CVWs, or some combination thereof. When the user type of the user indicates a “reviewer” type, the user may affirm one or more documents “reviewed” (or some other appropriate status) after generation, execution, or some combination thereof. The document(s) may additionally require a subsequent “supervisor” review, depending on the requirements of the pertinent CVWs. It should be understood that a user may have more than one user type, e.g., a supervisor may additionally execute CVW and provide real-time data/inputs, without departing from the scope of the present invention.

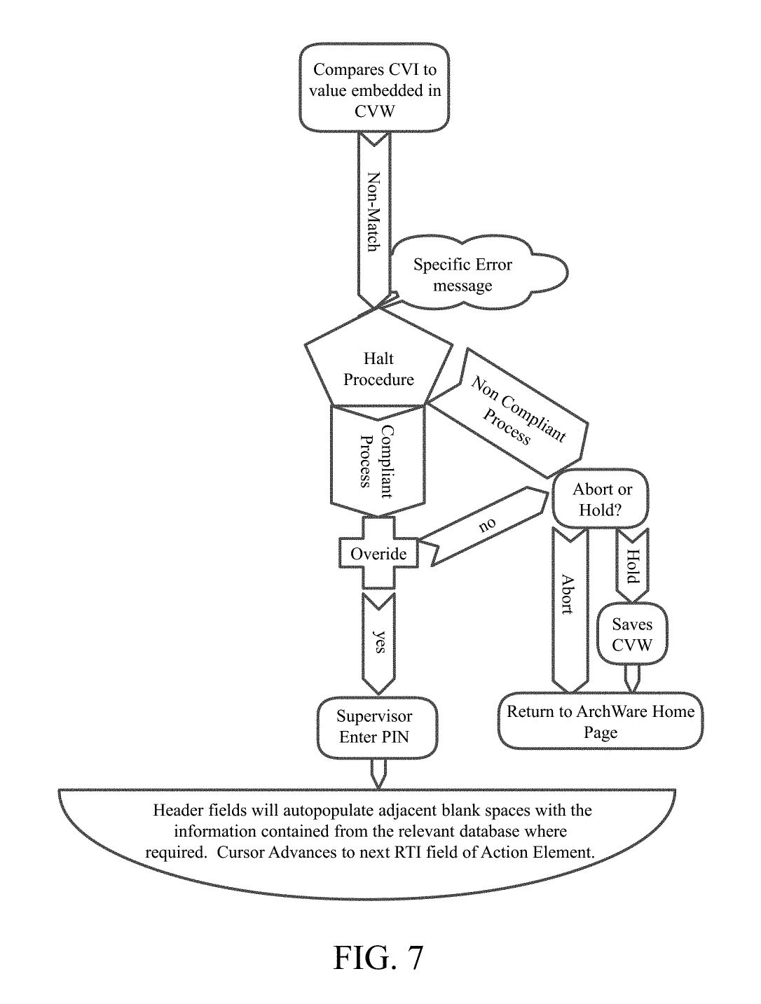

As shown in FIG. 7, any method, process, step, or other element may encounter a condition that prevents further execution, such as when a compliance metric has not been met during procedural execution, such as described throughout, shown in the FIGURES, or some combination thereof. In those types of instances, shown throughout the FIGURES, a “halt”-type method/process/steps proceed as generally shown in FIG. 7.

Advantageously, aspects of the present invention provide significant safety and efficiency benefits. Pre-process or pre-production review insures any and all metrics, regulatory requirements and specifications have been meet and maintained through any procedure requiring a traditional review. All data collected is verified instantaneously, insuring compliance metrics. This new electronic process mitigates many of the inherent risks associated with the review of a procedure after a process has been completed. As the process is being reviewed and verified in real time, no further review cycle is required. Furthermore, according to aspects of the present invention, procedures using Real Time Compliance (RTC) may be viewed remotely, which reduces and often eliminates the need for costly onsite visits, which in turn significantly accelerates production turnaround times and regulatory approvals.

RTC manages the need for audits and reviews comprehensively into a single platform. Simplifying Quality management systems (“QMS”) and the need to identify separate and independent programs to support the quality management system. Organizations will no longer need to learn multiple, complex management systems to maintain the QMS. QMSes can be maintained on this single platform. Any element of the process can be viewed and verified from program inception to final result or product comprehensively, while eliminating the need for multiple and unrelated programs or processes (including manual file and archiving) to demonstrate quality and compliance metrics.

As described above, it should be apparent that the various elements, components, modules, structures, systems or methods described throughout may be accomplish through alternate means without departing from the scope of the present invention. One of ordinary skill in the pertinent arts will recognize that, while various aspects of the present invention are illustrated in the FIGURES as separate elements, one or more of the elements may be combined, merged, omitted, or otherwise modified without departing from the scope of the present invention.

One of ordinary skill in the pertinent arts will recognize that, while various aspects of the present invention are illustrated in the Figures as separate elements, one or more of the elements may be combined, merged, omitted, or otherwise modified without departing from the scope of the present invention. Furthermore, lines, arrows, and connectors shown between various elements in the FIGURES typically demonstrate the flow of information or interaction therebetween, or some combination thereof. One of ordinary skill in the pertinent arts will understand that such flow or interaction may utilize any communication channel or medium, dedicated or shared, that permits such interaction, e.g., a logical connection, a physical connection, TCP, UDP, etc., without departing from the scope of invention.

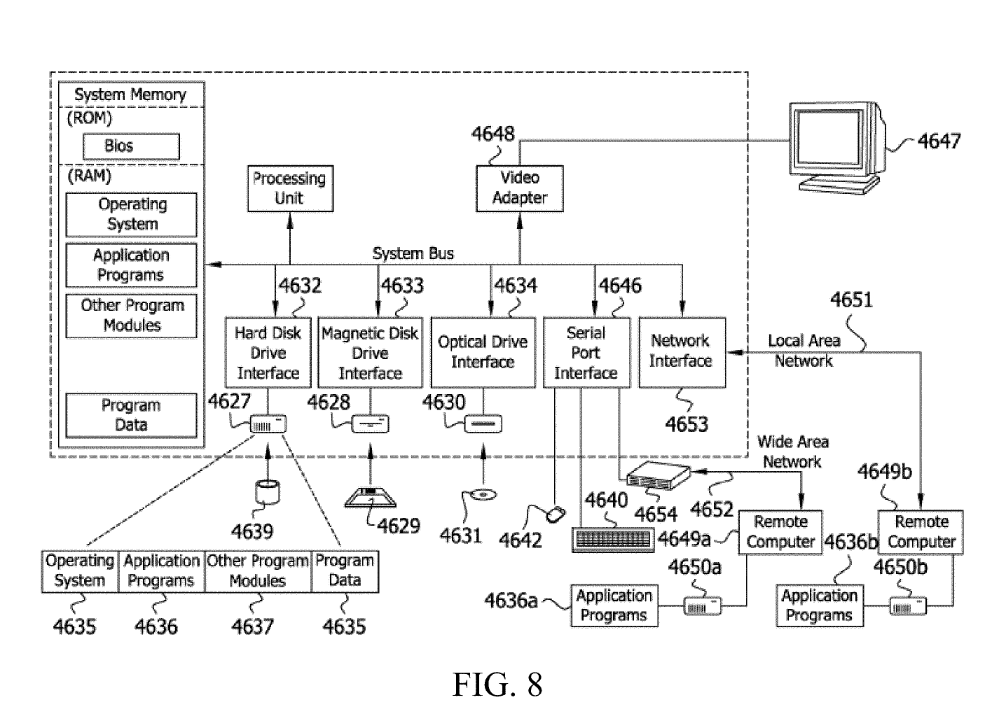

With reference to FIG. 8, an exemplary system for implementing aspects of the invention includes a general purpose computing device in the form of a conventional computer 4320, including a processing unit 4321, a system memory 4322, and a system bus 4323 that couples various system components including the system memory 4322 to the processing unit 4321. The system bus 4323 may be any of several types of bus structures including a memory bus or memory controller, a peripheral bus, and a local bus using any of a variety of bus architectures. The system memory includes read only memory (ROM) 4324 and random access memory (RAM) 4325. A basic input/output system (BIOS) 4326, containing the basic routines that help transfer information between elements within the computer 20, such as during start-up, may be stored in ROM 4324.

The computer 4320 may also include a magnetic hard disk drive 4327 for reading from and writing to a magnetic hard disk 4339, a magnetic disk drive 4328 for reading from or writing to a removable magnetic disk 4329, and an optical disk drive 4330 for reading from or writing to removable optical disk 4331 such as a CD-ROM or other optical media. The magnetic hard disk drive 4327, magnetic disk drive 4328, and optical disk drive 30 are connected to the system bus 4323 by a hard disk drive interface 4332, a magnetic disk drive-interface 33, and an optical drive interface 4334, respectively. The drives and their associated computer-readable media provide nonvolatile storage of computer-executable instructions, data structures, program modules, and other data for the computer 4320. Although the exemplary environment described herein employs a magnetic hard disk 4339, a removable magnetic disk 4329, and a removable optical disk 4331, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 4339, magnetic disk 4329, optical disk 4331, ROM 4324, and/or RAM 4325, including an operating system 4335, one or more application programs 4336, other program modules 4337, and program data 4338. A user may enter commands and information into the computer 4320 through keyboard 4340, pointing device 4342, or other input devices (not shown), such as a microphone, joy stick, game pad, satellite dish, scanner, or the like. These and other input devices are often connected to the processing unit 4321 through a serial port interface 4346 coupled to system bus 4323. Alternatively, the input devices may be connected by other interfaces, such as a parallel port, a game port, or a universal serial bus (USB). A monitor 4347 or another display device is also connected to system bus 4323 via an interface, such as video adapter 4348. In addition to the monitor, personal computers typically include other peripheral output devices (not shown), such as speakers and printers.

The computer 4320 may operate in a networked environment using logical connections to one or more remote computers, such as remote computers 4349 a and 4349 b. Remote computers 4349 a and 4349 b may each be another personal computer, a server, a router, a network PC, a peer device or other common network node, and typically include many or all of the elements described above relative to the computer 4320, although only memory storage devices 4350 a and 4350 b and their associated application programs 36 a and 36 b have been illustrated in FIG. 1. The logical connections depicted in FIG. 1 include a local area network (LAN) 4351 and a wide area network (WAN) 4352 that are presented here by way of example and not limitation. Such networking environments are commonplace in office-wide or enterprise-wide computer networks, intranets and the Internet.

When used in a LAN networking environment, the computer 4320 is connected to the local network 4351 through a network interface or adapter 4353. When used in a WAN networking environment, the computer 4320 may include a modem 4354, a wireless link, or other means for establishing communications over the wide area network 4352, such as the Internet. The modem 4354, which may be internal or external, is connected to the system bus 4323 via the serial port interface 4346. In a networked environment, program modules depicted relative to the computer 4320, or portions thereof, may be stored in the remote memory storage device. It will be appreciated that the network connections shown are exemplary and other means of establishing communications over wide area network 4352 may be used.

One or more aspects of the invention may be embodied in computer-executable instructions (i.e., software), such as a software object, routine or function (collectively referred to herein as a software) stored in system memory 4324 or non-volatile memory 4335 as application programs 4336, program modules 4337, and/or program data 4338. The software may alternatively be stored remotely, such as on remote computer 4349a and 4349b with remote application programs 4336b. Generally, program modules include routines, programs, objects, components, data structures, etc. that perform particular tasks or implement particular abstract data types when executed by a processor in a computer or other device. The computer executable instructions may be stored on a computer readable medium such as a hard disk 4327, optical disk 4330, solid state memory, RAM 4325, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

A programming interface (or more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a run-time system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the provided detailed description. Some illustrative implementations of a programming interface may also include factoring, redefinition, inline coding, divorce, rewriting, to name a few. There are, however, other ways to implement a programming interface, and, unless expressly excluded, these, too, are intended to be encompassed by the claims set forth at the end of this specification.

Embodiments within the scope of the present invention also include computer-readable media and computer-readable storage media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1: A Continuous Verification (CV) system, said system comprising:
a computer processor;
a system memory, said memory having stored thereon computer processor-executable instructions for a field-fillable document conversion and verification process, said instructions comprising instructions for:
analyzing one or more entries contained in a document;
defining a rules set based on said analyzing;
converting said document into a Continuous Verification Worksheet (CVW);
selectively receiving user input related to one or more fillable fields in said CVW;
comparing said received user input to said rules; and
selectively halting said process based on said comparing.

2: The CV system of claim 1, wherein said receiving user input includes one of a user manually entering information in one or more fields of a user interface and a user activating a remote device that provides information.

3: The CV system of claim 2, wherein said remote device comprises a bar code scanning device.
